(19) United States
(12) Patent Application Publication
(10) Pub. No.: US 2020/0079318 A1
(43) Pub. Date: Mar. 12, 2020

(54) Vehicle Passenger Detection System

(71) Applicant: Tribus Beheer B.V., Utrecht (NL)

(72) Inventors: Eric van Vliet, Rotterdam (NL); John Bell, Carlisle (GB)

(21) Appl. No.: 16/569,039

(22) Filed: Sep. 12, 2019

(30) Foreign Application Priority Data
Sep. 12, 2018 (EP) 18193982.8

(51) Int. Cl. B60R 22/48; B60R 16/023; B60N 2/00

(52) U.S. Cl. CPC B60R 22/48; B60R 16/023; B60Y 2200/51; B60R 2022/4816; B60Y 2200/143; B60N 2/002

(57) ABSTRACT

A passenger transport system comprising at least one electromechanical self-powering RF signal generator having a push & return mechanism, and at least one passenger seat having a seat region, wherein said push & return mechanism is installed, said generator, which is provided with an RF transmitter, is equipped to self-generate electric power based on a mechanical force applied on the push & return mechanism by a passenger sitting in the seat region, and whereby said generated electric power is used for the RF transmitter to transmit an RF signal on an adjustable frequency in case the passenger sitting in the seat region thereby presses a switch of the push & return mechanism, and which passenger transport system further comprises: a central RF receiver for receiving transmitted RF signals which have features to identify the individual passenger seats he RF signals are transmitted from, and means for based on the received RF signals deriving information indicating which of the passenger seats are and/or are not occupied.

### CROSS-REFERENCE TO RELATED APPLICATIONS

This application claims priority to and the benefit of Europe Patent Application No. 18193982.8, entitled “Vehicle Passenger Detection System”, filed on Sep. 12, 2018, and the specification and claims thereof are incorporated herein by reference.

### BACKGROUND OF THE INVENTION

Embodiments of the present invention relate to a passenger transport system. Embodiments of the present invention also relate to a vehicle provided with such a passenger transport system.

A passenger transport system with a pressure sensor for a car seat with wireless communication is known from US 2018/0056814 A1. Depending on the weight sensed by the pressure sensor installed in a car seat, the system is configured to switch a wireless signal on and off for communication to a portable electronic device. This is applied as a safety feature and a reminder message is being sent to the portable device held by the parent or guardian of a child to address the issue that the child is accidently left in the car seat.

### BRIEF SUMMARY OF THE INVENTION

It is an object of the embodiments of the present invention to provide a more general applicable passenger transport system, suited to provide passenger presence and possible passenger safety information to the person, such as drivers of the vehicle, and also to increase a safe and more efficient vehicle transport.

A passenger transport system according to an embodiment of the present invention preferably comprises: at least one electromechanical self-powering RF signal generator comprising a push & return mechanism; at least one passenger seat having a seat region, wherein said push & return mechanism is preferably installed; said generator, which is preferably provided with an RF transmitter, is preferably equipped to self-generate electric power based on a mechanical force applied on the push & return mechanism by a passenger sitting in the seat region; whereby said generated electric power is preferably used for the RF transmitter to transmit an RF signal on an adjustable frequency in case the passenger sitting in the seat region thereby presses a switch of the push & return mechanism; a central RF receiver for receiving transmitted RF signals which comprise features to identify the individual passenger seats the RF signals are transmitted from; and means for deriving information indicating which of the passenger seats are and/or are not occupied based on the received RF signals.

It is an advantage of embodiments of the passenger transport system according to the present invention that the seat occupancy can be monitored, which can then be communicated by a driver of the vehicle in the usual way to incoming passengers, which are then certain at entering the vehicle that there are free seats available in the vehicle. This is particularly advantageous for those means of transport wherein only passengers occupying a seat may be transported.

In addition, the part of the passenger transport system installed in each of the passenger seats in a vehicle does not require any wiring to the central receiver part of the passenger transport system, which is normally close to the driver or conductor of the vehicle. This reduces wiring in the vehicles seats and from each of the seats to the central receiver part, and reduces manufacturing costs of the passenger transport system according to the invention, while its failsafe operation is warranted.

Furthermore the parts of the system in each of the seats and the communication to the RF receiver part does not require any local power, such as battery power, because use is made of the pressure applied by every passenger in their seats to generate locally required electric power by the electromechanical self-powering RF signal generator, known per se. The Enocean® energy harvesting and ultra-low power radio technology is an example thereof, which is also available in a version operating in Bluetooth® standard.

An embodiment of the passenger transport system according to the invention has the characterizing features that the at least one passenger seat has a safety belt and an associated safety belt switch whose switch position provides information about whether the passenger on the seat is buckled in or not.

Where possible that information about the switch position reflecting the passenger in the seat being buckled in or not may be combined with the occupancy information above in order to prevent that a confirmed seated passenger is not buckled in. Information about the fact that not all passengers are correctly buckled in can then for example be announced over the general vehicle audio system or shown on the dashboard.

A further embodiment of the passenger transport system according to the invention has the characterizing features that the passenger seats are individually identifiable, such as by uniquely numbering them.

If this information is available to, for example a bus driver, any individual passenger on the identifiable seat concerned can be informed over the bus audio system or if possible over the individual audio system such as available on hop-on hop-off busses that the seat belt of a particularly announced seat number is not buckled in correctly.

In another embodiment of the passenger transport system according to the invention, the passenger transport system comprises means for combining the information indicating which of the passenger seats are and/or are not occupied with the information, either or not communicated wirelessly to the means for combining, about whether the passenger on the seat is buckled in or not.

Technically seen either one or both separately, or only the combination of both aforementioned sorts of information can be communicated to the driver. The former cases are more elaborate, but more advanced and failsafe, because both sorts of information are available separately, which refers to Boolean OR processing both information. In the latter case if only the combination of information is available the one RF signal per seat represents proof that a person present on the seat is buckled in properly, which means less technique and Boolean and processing of both information is required for its technical realization.

### BRIEF DESCRIPTION OF THE SEVERAL VIEWS OF THE DRAWINGS

At present the passenger transport system according to the invention will be elucidated further together with its additional advantages with reference to the appended drawings, wherein similar components are being referred to by means of the same reference numerals. The accompanying drawings, which are incorporated into and form a part of the specification, illustrate one or more embodiments of the present invention and, together with the description, serve to explain the principles of the invention. The drawings are only for the purpose of illustrating one or more embodiments of the invention and are not to be construed as limiting the invention. In the drawings:

FIG. 1 shows a schematic view of an array of seats wirelessly connected to a central RF receiver close to a driver of the vehicle according to an embodiment of the present invention; and

FIG. 2a shows a cross section of a seat region of a seat for a vehicle and FIG. 2b shows a detail of the switching of an electromechanical self-powering RF signal generator provided therein, according to an embodiment of the present invention.

### DETAILED DESCRIPTION OF THE INVENTION

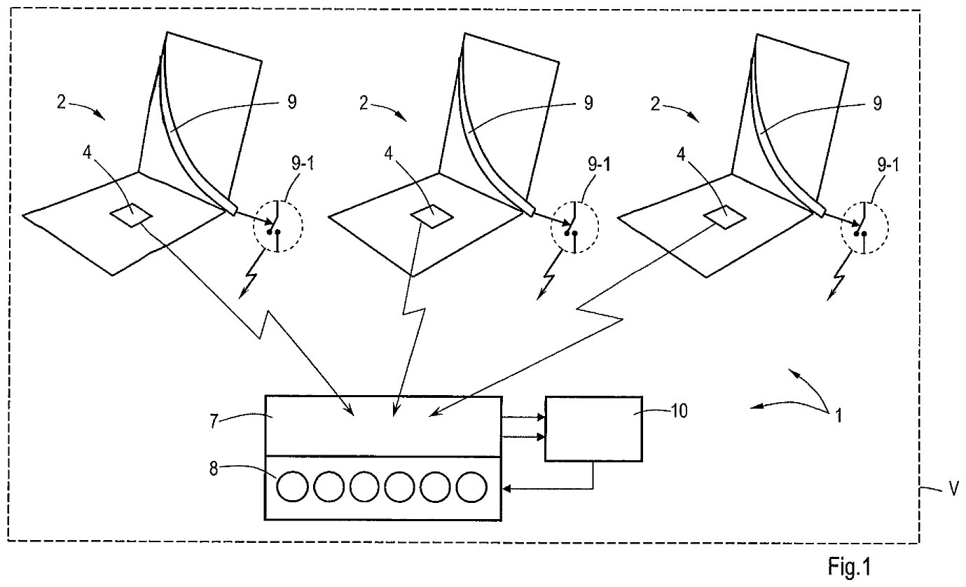

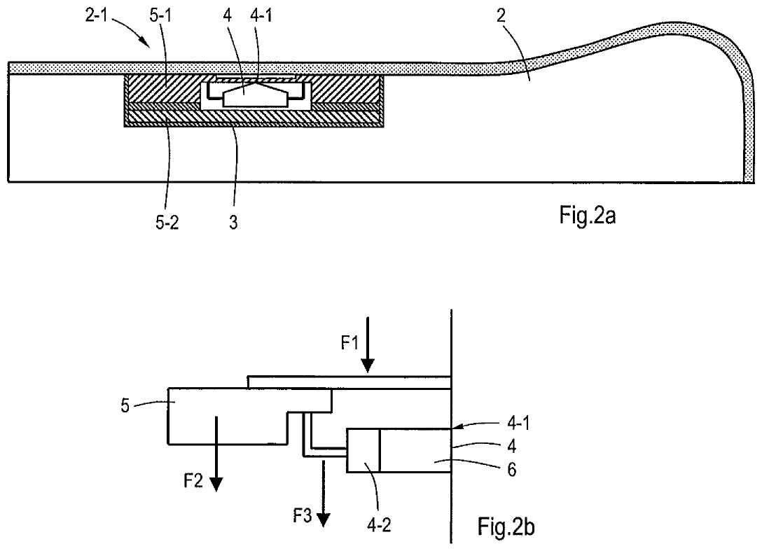

FIG. 1 schematically shows a passenger transport system 1 meant to be installed in for example a vehicle V, such as a train, tram, bus, underground, subway, airplane, double deck bus, double deck train, biplane or the like. Also referring to FIGS. 2a and 2b, the several passenger seats 2 placed therein each have a seat region 2-1 with therein a cavity 3 for accommodating an electromechanical self-powering RF signal generator 4. Such a generator 4 has a push & return mechanism 4-1 whereon the weight F1 of a passenger sitting in the seat 2 is used to derive electric power there from. In the mechanism 4-1 a foam may be used in the seat region 2 as a means of retaining comfort for the sitting passenger which foam also provides a means to return the mechanism 4-1 to its unoccupied position. In particular, the foam is positioned between an upper plate 5-1 and a bottom plate 5-2. The mentioned Enocean® energy harvesting and ultra-low power radio technology goes well together with such an embodiment of the mechanism 4-1. The weight F1 is also used to apply a force F2 on the upper plate 5-1 in the cavity 3 which in turn applies a switching force F3 on a switch 4-2 of the generator 4. The generator 4 is provided with an RF transmitter 6 which based on its own generated electric power transmits an RF signal if the force F3 is applied on the switch 4-2. With an RF transmitter 6 any wireless transmitter is meant which is capable of wirelessly sending a high frequency signal, at any speed but preferably with a low transmission speed, and according to any protocol or standard, such as Bluetooth®. The RF signal may hold a data payload with an individual label of the seat 2 concerned, such as its unique number. In order not to disturb RF signals transmitted by other generators 4 in the same or a neighboring vehicle, the adjustable transmitter frequencies differ, or at least some other technical measure is taken, such as some form of multiplexing, to safeguard an undisturbed receipt of the various RF signals.

The passenger transport system 1 preferably further comprises a central RF receiver 7 for receiving transmitted RF signals which have features to identify the individual passenger seats 2 the RF signals are transmitted from, and means 8 for based on the received RF signals deriving information indicating which of the passenger seats are and/or are not occupied. The means 8 may include graphic means to indicate this relevant information to the driver.

Nowadays vehicles have on their passenger seats a safety belt 9 and an associated safety belt switch, either or not electromechanical, switch 9-1 whose switch position provides information about whether the passenger on the seat 2 is buckled in or not. It may be that in existing vehicles the seat belt information is already available to the driver, but if not, the existing vehicle can, without requiring wiring the whole vehicle, easily be supplemented with the passenger transport system 1 if the seats 2 are being replaced.

It is advantageous to combine the seat belt information with the above elucidated occupancy information with the help of combination means 10 and to provide that separate and/or combined to the driver or conductor to confirm that everyone that is seated is buckled in and respectively that there are still free seats available somewhere in the vehicle. This requires Boolean OR processing because both two sorts of information may qualify independent from the other to transmit its corresponding RF signal to the driver.

And if the seat number information is made available by the system 1 the driver knows about the free seat and knows where the free seat is situated in the vehicle so that he/she can communicate that to the passenger entering the vehicle. And/or some graphics system, such as with small LEDs above the seats, indicates where the free seats are located in the vehicle V.

In a passenger transport system 1 where the electronics of the occupancy information and the seat belt information would be combined, an RF signal is preferably only sent by the seat generators transmitter if and when the seat is occupied and the person seated is buckled in. This requires AND processing both two sorts of information, before the RF signal is transmitted.

As may be desired, the aforementioned information can be stored in a local memory, and/or stored in an application or website for later analysis and verification purposes.

Note that in the specification and claims, “about” or “approximately” means within twenty percent (20%) of the numerical amount cited.

Although the invention has been described in detail with particular reference to the disclosed embodiments, other embodiments can achieve the same results. Variations and modifications of the present invention will be obvious to those skilled in the art and it is intended to cover in the appended claims all such modifications and equivalents. The entire disclosures of all references, applications, patents, and publications cited above are hereby incorporated by reference. Unless specifically stated as being “essential” above, none of the various components or the interrelationship thereof are essential to the operation of the invention. Rather, desirable results can be achieved by substituting various components and/or reconfiguration of their relationships with one another.

1. A passenger transport system comprising:
at least one RF signal generator comprising a push & return mechanism;
at least one passenger seat comprising a seat region, wherein said push & return mechanism is installed;
wherein said RF signal generator is provided with an RF transmitter and is equipped to self-generate electric power based on a mechanical force applied on said push & return mechanism by a passenger sitting in the seat region;
wherein said generated electric power is used for the RF transmitter to transmit an RF signal on an adjustable frequency in case the passenger sitting in the seat region thereby presses a switch of said push & return mechanism;
a central RF receiver for receiving transmitted RF signals which comprise features to identify the individual passenger seats the RF signals are transmitted from; and
means for deriving information indicating which of said at least one passenger seat are and/or are not occupied, based on the received RF signals.

2. The passenger transport system according to claim 1, wherein said at least one passenger seat comprises a safety belt and an associated safety belt switch, wherein said safety belt switch provides information about whether the passenger on said at least one passenger seat is buckled in or not.

3. The passenger transport system according to claim 2, wherein said passenger seats are individually identifiable.

4. The passenger transport system according to claim 3, further comprising means for combining said information indicating which of said at least one passenger seat are and/or are not occupied with the information with said information about whether the passenger on said at least one passenger seat is buckled in or not.

5. The passenger transport system according claim 4, wherein said means for combining are equipped to pinpoint those passenger seat(s) whereon the passengers occupying those seats are and/or are not buckled in properly.

6. The passenger transport system according to claim 5, wherein said means for combining comprise AND and/or OR devices for Boolean processing said information indicating which of the passenger seats are and/or are not occupied and said information about whether the passenger on the seat is buckled in or not.

7. A vehicle provided with a passenger transport system according to claim 1.

8. A vehicle according to claim 7 which is a train, a bus, a tram, an airplane, a double deck bus, a double deck train, or a biplane.
